(19) United States
(12) Patent Application Publication
(10) Pub. No.: US 2007/0217210 A1
(43) Pub. Date: Sep. 20, 2007

(54) Light emitting device unit for AC voltage

(75) Inventors: Jae-wook Jeong, Seoul (KR); Hyung-kun Kim, Suwon-si (KR); Jae-hee Cho, Yongin-si (KR); Yu-sik Kim, Suwon-si (KR)

Correspondence Address: BUCHANAN, INGERSOLL & ROONEY PC, POST OFFICE BOX 1404, ALEXANDRIA, VA, 22313-1404, US

(73) Assignee: Samsung Electro-Mechanics Co., Ltd., Suwon-si (KR)

(21) Appl. No.: 11/655,830

(22) Filed: Jan. 22, 2007

(30) Foreign Application Priority Data
Mar. 20, 2006 (KR) 10-2006-0025212

(51) Int. Cl. B60Q 1/06

(52) U.S. Cl. 362/428

(57) ABSTRACT

A light emitting diode unit for AC voltage is provided. The light emitting diode unit includes a sub-mount on which electric wires are formed; a first light emitting diode array in which a plurality of first light emitting diodes are serially connected to the sub-mount; and a second light emitting diode array, in which a plurality of second light emitting diodes are connected to the sub-mount as bridge circuits, connecting to the first light emitting diode array. Therefore, rectification can be performed through the bridge circuit without an additional rectifying device by connecting the light emitting diodes to the bridge circuit in series, and thus the structure of the unit can be simplified and a size of the light emitting diode unit can be reduced.

### CROSS-REFERENCE TO RELATED PATENT APPLICATIONS

This application claims the benefit of Korean Patent Application No. 10-2006-0025212, filed on Mar. 20, 2006, in the Korean Intellectual Property Office, the disclosure of which is incorporated herein in its entirety by reference.

### BACKGROUND OF THE DISCLOSURE

1. Field of the Disclosure

The present disclosure relates to a light emitting device unit for alternating current (AC) voltage, and more particularly its a light emitting device unit of reduced size using a bridge circuit having an improved light emitting efficiency.

2. Description of the Related Art

Light emitting devices, for example, light emitting diodes, can be utilized in a variety of areas, such as in liquid crystal display (LCD) backlight units, flash of camera phones, display screens, and lightings. The light emitting diode generates electrons and holes using a p-n junction structure of a semiconductor, and emits light using a re-combination of the p-n structure. The light emitting diode consumes less electric power than conventional light bulbs and fluorescent lights, and has a longer lifespan than light bulbs and fluorescent lights. Thus, research for utilizing the light emitting diodes in general lighting actively is being pursued.

In general, in order to use the light emitting diode in general lighting, a single light emitting chip is formed using a packaging process, the light emitting diodes are connected in series or in parallel, and a protecting circuit and a direct current (DC)/alternating current (AC) converter are installed on an outer portion to form the light emitting diode in the shape of a lamp. However, when the lighting is manufactured using a plurality of packaged light emitting devices, the size of the light emitting device itself becomes larger, and moreover, the space between the devices becomes larger. Therefore, the size of the light source is very large.

In applications where the light emitting diode is used for lighting, an AC voltage is used as the electric power, and thus a light emitting apparatus that can improve the light emitting efficiency may be realized. FIG. 1 illustrates a light emitting apparatus disclosed in International Publication No. WO 2004/023568. The light emitting apparatus of FIG. 1 includes a first light emitting diode array 1 and a second light emitting diode array 2 parallelly connected to opposite polarities of each other in order to use the AC voltage as the electric power for lighting. Reference numeral 32 denotes an electrode, and reference 34 denotes an intersection generated when the first and second light emitting diode arrays 1 and 2 are arranged in zigzag.

When the AC voltage is applied, the first light emitting diode array 1 emits the light during a first half period, and the second light emitting diode array 2 emits the light during the remaining half period. Therefore, during the application of AC voltage, half of the entire light emitting diodes emit the light, and thus the number of the entire light emitting diodes increases.

In order to solve the above problem, a method that can improve the light emitting efficiency and at the same time does not increase the number of the light emitting diodes by including a rectifier diode has been suggested. However, the rectifier diode has a larger volume and additionally should be fabricated. Thus, the fabrication processes of the light emitting diode become complex, and costs for fabricating the light emitting diode increase. Therefore, it is not suitable for the light emitting device applied in a small size light source to adopt an additional rectifier diode.

### SUMMARY OF THE DISCLOSURE

The present invention may provide a light emitting diode unit for AC voltage that can improve a light emitting efficiency by connecting light emitting diodes to a bridge circuit in serial and can reduce fabrication costs by simplifying fabricating processes.

According to an aspect of the present invention, there is provided a light emitting diode unit for alternating current (AC) voltage, the light emitting diode unit including a sub-mount, on which electric wires are formed; a first light emitting diode array, in which a plurality of first light emitting diodes are serially connected to the sub-mount; and a second light emitting diode array, in which a plurality of second light emitting diodes are connected to the sub-mount in the form of a bridge circuit, connecting to the first light emitting diode array.

The first light emitting diode and the second light emitting diode may be light emitting chips.

A breakdown voltage (V_{b}) of the second light emitting diode may satisfy following equation,

$${V}_{b} > \frac{( {V}_{p} - {nV}_{f} )}{n} ,$$

where V_{f} denotes a forward voltage of the second light emitting diode, Vₚ denotes a maximum value of the supplied voltage, and n denotes the number of second light emitting diodes arranged on a side of the bridge circuit.

The first and second light emitting diodes may be mounted on the sub-mount as flip chips.

The number of first and second light emitting diodes that emit light during a half period of the AC voltage may be larger than a value of (Vₚ/V_{f}) when V_{f} denotes the forward voltages applied to the first and second light emitting diodes and Vₚ denotes a maximum value of the supplied voltage.

### BRIEF DESCRIPTION OF THE DRAWINGS

The above and other features and advantages of the present invention will be described in detailed exemplary embodiments thereof with reference to the attached drawings in which:

FIG. 1 is a view showing a light emitting apparatus disclosed in International Publication No. WO 2004/023568;

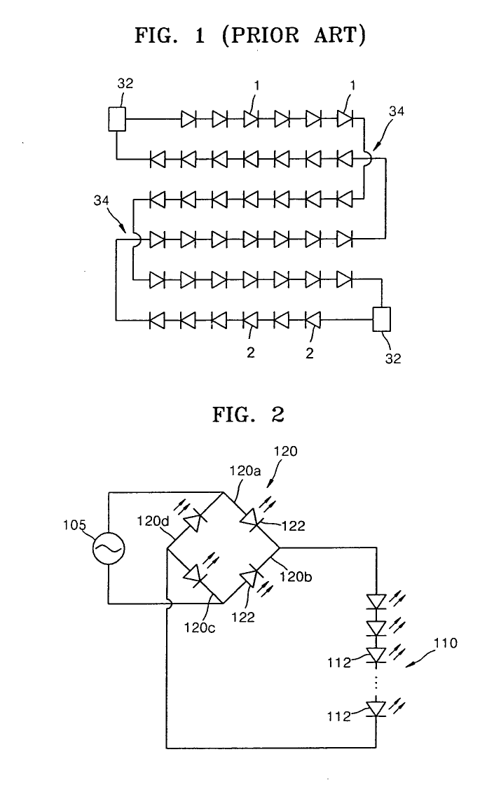

FIG. 2 is an equivalent circuit diagram of a light emitting device unit for AC voltage according to an embodiment of the present invention;

FIG. 3 is a view showing the light emitting device unit for AC voltage according to the embodiment of the present invention;

FIGS. 4A and 4B are views illustrating light emitting operations of the light emitting device unit of FIG. 3; and

FIG. 5 is a cross-sectional view showing an exemplary embodiment of a light emitting chip adopted in the light emitting device unit for AC voltage according to the present invention.

### DETAILED DESCRIPTION OF EXEMPLARY EMBODIMENTS

A light emitting device unit according to the present invention is to be applied to light emitting apparatuses using an alternating current (AC) voltage, and the light emitting diodes are connected in the form of a bridge circuit to make the diodes perform a rectifying performance, and thus the light emitting efficiency can be improved.

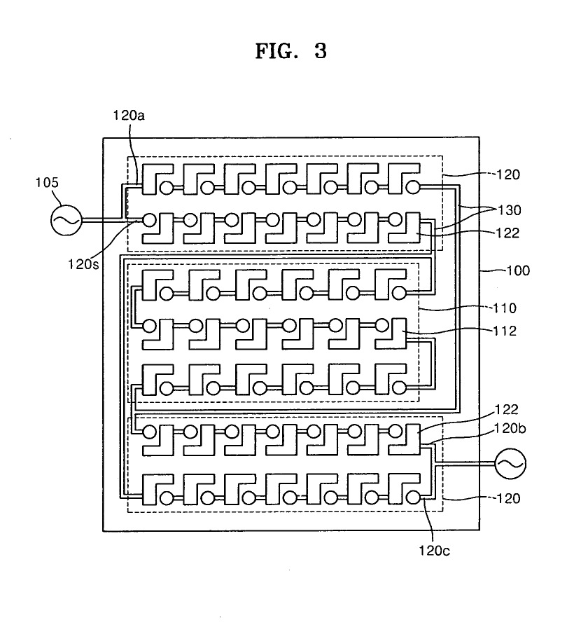

Referring to FIG. 2, the light emitting device unit according to an embodiment of the present invention includes a first light emitting diode array 110 formed by connecting a plurality of first light emitting diodes 112 in series, and a second light emitting diode array 120 formed by connecting a plurality of second light emitting diodes 122 in the form of a bridge circuit. The first and second light emitting diode arrays 110 and 120 are connected to each other in series, and an AC voltage is supplied to the arrays 110 and 120 from a power unit 105.

The second light emitting diodes are coupled to each other in the form of a bridge circuit. The bridge circuit includes first through fourth sides 120a, 120b, 120c, and 120d, one of the second light emitting diodes 122 can be disposed on one side of the bridge circuit or a plurality of second light emitting diodes can be connected in series on one side of the bridge circuit. The second light emitting diode array 120 performs the rectifying function by arranging the light emitting diodes in the form of the bridge circuit.

The first and second light emitting diodes 112 and 122 may be light emitting chips or packaged light emitting devices. That is, the light emitting diode unit can be fabricated as a printed circuit board (PCB) using the packaged light emitting device, or on the chip level using the light emitting chip. If the light emitting diode unit is fabricated as the light emitting chip, the packaging the light emitting device is not required, and thus the fabrication costs can be reduced and the size of the light emitting diode unit can be smaller than that of the PCB level light emitting diode unit.

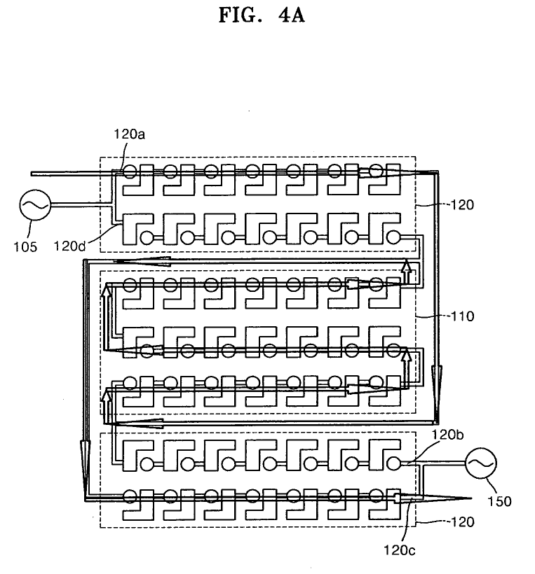

FIG. 3 illustrates an example of the light emitting diode unit having the light emitting diodes in a 7×7 arrangement. Electric wires 130 are formed on a sub-mount 100, and the first and second light emitting diodes 112 and 122 are mounted along the electric wires 130. FIG. 3 illustrates an exemplary electrode structure of the light emitting diodes for convenience.

The first light emitting diodes 112 are connected to each other in series, and the second light emitting diodes 122 are arranged in the formed of bridge circuit. Seven of the second light emitting diodes 122 are serially connected to a side of the bridge circuit. The connection of seven second light emitting diodes is presented for exemplary purposes only, and the number of second light emitting diodes can be freely changed if the reverse voltage applied to one of the second light emitting diodes is smaller than a breakdown voltage (V_{b}).

The breakdown voltage (V_{b}) of the second light emitting diodes 122 may satisfy following equation.

$${V}_{b} > \frac{( {V}_{p} - {nV}_{f} )}{n} \qquad ( 1 )$$

Here, V_{f} denotes a forward voltage of the second light emitting diode, Vₚ denotes a maximum value of the supplied voltage, and n denotes the number of second light emitting diodes arranged on a side of the bridge circuit. That is, the breakdown voltage (V_{b}) of the second light emitting diode 122 should be larger than the reverse voltage. For example, when it is assumed that Vₚ=110(V), n=7, and V_{f}=3.5(V), V_{b} may be larger than 12(V). Within the range where the reverse voltage of the second light emitting diode satisfies the above Equation 1, the number (n) of the second light emitting diodes can be determined.

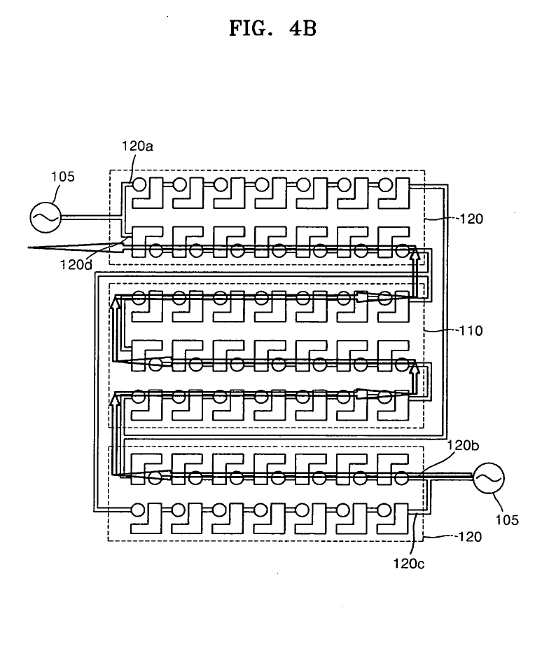

The light emitting operation of the light emitting device unit will be described with reference to FIGS. 4A and 4B.

FIG. 4A illustrates a forward flow of electric current during a first half period of the AC voltage supplied from the power unit 105, and FIG. 4B illustrates a reverse flow of the electric current during a second half period of the AC voltage. In the first half period, the electric current flows through the second light emitting diodes on the first side 120a, and the first light emitting diodes 112 and the second light emitting diodes on the third side 120c. Meanwhile, in the second half period, the electric current flows through the second light emitting diodes on the second side 120b, and the first light emitting diodes 112 and the second light emitting diodes on the fourth side 120d. That is, the second light emitting diodes alternately emit the light in halves, and the first light emitting diodes continuously emit the light. The second light emitting diodes simultaneously perform the rectifying operation and the light emitting operation. Therefore, the light emitting efficiency of the light emitting diode unit of the present invention can be higher than that of the conventional light emitting diode of the parallel structure. The number of the first and second light emitting diodes emitting the light during the half period of the AC voltage is larger than the value of Vₚ/V_{f}.

In addition, the first and second light emitting diodes 112 and 122 can be mounted on the sub-mount 100 as flip chips. Since the light emitting diodes can be mounted as the flip chips without wires, the fabrication processes of the light emitting diode can be simplified, and intervals between the light emitting diodes can be reduced, and thus the light emitting diode unit can be minimized in size.

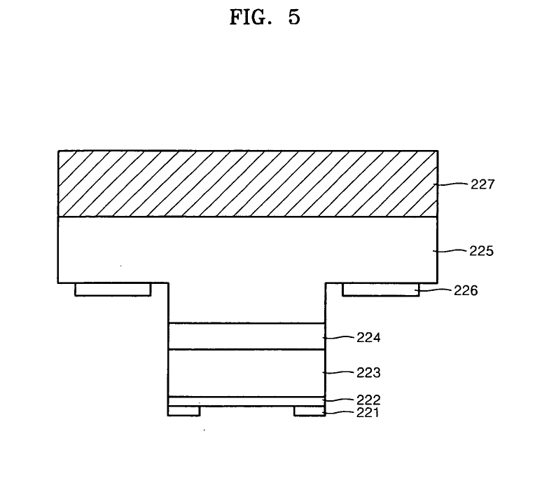

FIG. 5 shows an example of the light emitting diode. In the light emitting diode, an n-type clad layer 225, on which electrons are doped, an active layer 224, a p-type clad layer 223, and a p-type electrode 221 are sequentially stacked on a sapphire substrate 227. In addition, an n-type electrode 226 is disposed on a portion on a lower surface of the n-type clad layer 225. The n-type clad layer 225 is stepped, and the n-type electrode 226 is disposed on the stepped portion.

A positive voltage and a negative voltage are applied to the p-type electrode 221 and the n-type electrode 226 in the forward direction, and the electrons and holes are transferred from the p-type and n-type clad layers 223 and 225 to the active layer 224. The electrons and holes are combined to generate photons having an energy corresponding to an energy band gap, and thus the light is emitted. The light emitting diodes having the above structure are arranged along the wires on a sub-mount 220, and then are mounted using flip chips, and thus the light emitting diode unit can be readily fabricated. Reference numeral 230 denotes a bonding metal. The light emitting diode unit can be fabricated using the light emitting diode that includes the p-type electrode and the n-type electrode disposed on opposite surfaces to each other.

According to the present invention, since the light emitting diodes are arranged in the form of a bridge circuit to make the light emitting diodes perform the rectifying function and the light emitting function, the light emitting efficiency of the light emitting diode unit can be improved, and the size of the unit can be reduced.

As described above, the light emitting diode unit according to the present invention performs the rectifying operation using the bridge circuit without an additional rectifying device by connecting the light emitting diodes to the bridge circuit in series, and thus the structure of the light emitting diode unit can be simplified and the size of the unit can be reduced. In addition, the light emitting efficiency can be improved by performing the rectifying operation using the bridge circuit. Also, since the rectifying operation can be performed by arranging the light emitting diodes without an additional rectifying device, the costs for fabricating the light emitting diode unit can be reduced. The light emitting diode unit having the small size and high brightness can be effectively utilized as the light source of the lighting using AC voltage.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light emitting diode unit for alternating current (AC) voltage, the light emitting diode unit comprising:
a sub-mount, on which electric wires are formed;
a first light emitting diode array in which a plurality of first light emitting diodes are serially connected to the sub-mount; and
a second light emitting diode array, in which a plurality of second light emitting diodes are connected to the sub-mount in the form of a bridge circuit connecting to the first light emitting diode array.

2. The light emitting diode unit of claim 1, wherein the first light emitting diode and the second light emitting diode are light emitting chips.

3. The light emitting diode unit of claim 1, wherein a breakdown voltage (V_{b}) of the second light emitting diode satisfies following equation,
$${V}_{b} > \frac{( {V}_{p} - {nV}_{f} )}{n} ,$$
where V_{f} denotes a forward voltage of the second light emitting diode, Vₚ denotes a maximum value of the supplied voltage, and n denotes the number of second light emitting diodes arranged on a side of the bridge circuit.

4. The light emitting diode unit of claim 1, wherein the first and second light emitting diodes are mounted on the sub-mount as flip chips.

5. The light emitting diode unit of claim 1, wherein one of the second light emitting diodes is connected to a side of the bridge circuit, or a plurality of the second light diodes are serially connected to a side of the bridge circuit.

6. The light emitting diode unit of claim 1, wherein the number of first and second light emitting diodes that emit light during a half period of the AC voltage is larger than a value of (Vₚ/V_{f}) when V_{f} denotes the forward voltages applied to the first and second light emitting diodes and Vₚ denotes a maximum value of the supplied voltage.
